(19) United States
(12) Patent Application Publication
(10) Pub. No.: US 2025/0231824 A1
(43) Pub. Date: Jul. 17, 2025

(54) Application Sharing Between Endpoint Devices

(71) Applicant: Google LLC, Mountain View, CA (US)

(72) Inventors: Taylor Bessette, San Jose, CA (US); Yuk Yin Maurice Lam, Sunnyvale, CA (US); Liza Ma, Sunnyvale, CA (US); Daniel Nishi, Mountain View, CA (US); Huang-Chi Chou, New Taipei City (TW)

(21) Appl. No.: 18/703,260

(22) PCT Filed: Oct. 21, 2022
(86) PCT No.: PCT/US2022/047402

§ 371 Date: Apr. 19, 2024

Related U.S. Application Data
(60) Provisional application No. 63/270,279, filed on Oct. 21, 2021.

(51) Int. Cl. G06F 9/54

(52) U.S. Cl. CPC G06F 9/547; G06F 9/546

(57) ABSTRACT

An endpoint framework is implemented for sharing one or more applications between one or more endpoint devices. To initiate sharing of an application, the system includes a first endpoint device running an application that generates notifications based on a condition or status of the application running. The first endpoint device provides these notifications to a second endpoint device which are output by the second endpoint device. The second endpoint device receives interactions with the output notifications and provides these interactions to the first endpoint device. In response to the interactions indicating the initiation of application sharing, the first endpoint device generates an application stream relating to the running application and provides it to the second endpoint device.

### BACKGROUND

In device ecosystems, multiple devices each having respective capabilities and running respective applications associated with those capabilities are networked together to provide their capabilities to one or more users. Traditionally, to add a new capability to the device ecosystem, a new device is added to the network that performs the new capability by running respective applications when requested by the network. However, adding a new device to the device ecosystem can be cumbersome and restrictive due to the limited operating systems and communication protocols supported by a device ecosystem, such as in a closed device ecosystem. Also, continually adding devices to the device ecosystem increases the complexity of managing the capabilities of each device within the device ecosystem.

Additionally, devices added to a device ecosystem are often tied to user data, restricting which device ecosystems the device is permitted to join. Further, many device ecosystems require that each device perform only applications associated with its capabilities.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of an endpoint device framework for sharing one or more applications, in accordance with some embodiments.

FIG. 2 is a block diagram of an endpoint device configured to share one or more applications or receive one or more shared applications within the endpoint device framework of FIG. 1, in accordance with some embodiments.

FIG. 3 is a signal flow diagram illustrating an example application sharing initiation operation for an endpoint device, in accordance with some embodiments.

FIG. 4 is a signal flow diagram illustrating an example application sharing operation for an endpoint device, in accordance with some embodiments.

FIG. 5 is a flow diagram illustrating a process for sharing one or more applications across endpoint devices, in accordance with some embodiments.

### SUMMARY OF EMBODIMENTS

Techniques and systems described herein are directed to providing flexibility in a device ecosystem of endpoint devices through the sharing of applications across one or more of the endpoint devices. According to an example embodiment, a method can include generating a notification related to an application running on a first endpoint device. Further, the method can include receiving, from a second endpoint device, a signal representing an interaction with the notification. Additionally, the method can include initiating an application stream based on the interaction with the notification and transmitting, by the first endpoint device, the application stream to the second endpoint device.

In embodiments, the method can further include determining a condition of the application (e.g., the application is out of date, the application is running, the application is suspended, the application has ended) running on the first endpoint device. The notification related to the application may be generated based on the condition of the application. Additionally, the condition can include an incoming phone call for the application. The method may further include determining an application control based on the interaction with the notification. The application stream can be initiated also based on the application control. Also, the application control can include at least one of an application stream initiation, an application quit, an application ignore, an application command, or any combination thereof.

Further, the method can include rendering a plurality of application frames based on the application running on the first endpoint device. The method can additionally include encoding the plurality of application frames to produce at least a portion of the application stream. In embodiments, the application stream can include at least a portion of a video call. Additionally, the method can include rendering audio data based on the application running on the first endpoint device and encoding the audio data to produce at least a portion of the application stream. Further, the application stream can include at least a portion of a phone call.

In another example embodiment, a method may include transmitting a notification related to an application running on a first endpoint device to a second endpoint device. Further, the method can include receiving, from the second endpoint device, data indicating an interaction with the notification. The method can also include, in response to the data indicating the interaction with the notification, generating an application stream representing at least a portion of the application running on the first endpoint device and transmitting the application stream to the second endpoint device.

In embodiments, the method may additionally include determining a condition of the application (e.g., the application is out of date, the application is running, the application is suspended, the application has ended) running on the first endpoint device and, in response to determining the condition of the application, generating the notification related to the application. The method can further include rendering audio data based on the application running on the first endpoint device and encoding the audio data to produce an encoded audio stream. In embodiments, the application stream can include the audio stream. The method may also include rendering a frame based on the application running on the first endpoint device and encoding the frame to produce an encoded video stream. In embodiments, the application stream may include the encoded video stream.

Generally, the notification can include a prompt to accept a call. Further, the notification can include a prompt to activate an input device of the second endpoint device. The methods can also include receiving, at the first endpoint device, data representing an interaction with at least a portion of the application stream from the second endpoint device. Additionally, the methods can also include modifying the application running on the first endpoint device based on the interaction with at least a portion of the application stream. Further, the methods can include generating a modified application stream based on the interaction with at least a portion of the application stream and transmitting the modified application stream to the second endpoint device.

In an additional example embodiment, a method can include outputting a notification related to an application running on a second endpoint device at a first endpoint device. Further, the method can include receiving an interaction with the notification and transmitting data representing the interaction with the notification to the first endpoint device. Additionally, the method can include receiving an application stream related to the application running on the second endpoint device from the second endpoint device.

In embodiments, the notification may be output by an output device including at least one of a display or speaker. Further, the method can include outputting at least a portion of the application stream by the output device. Also, the interaction can be received by an input device including a touchscreen, mouse, keyboard, remote control, microphone, or any combination thereof.

Additionally, the method can include receiving an interaction with the application stream by the input device and transmitting data representing the interaction with the application stream to the second endpoint device. The method may also include receiving a modified application stream based on the interaction with the application stream from the second endpoint device. Further, the method may include decoding at least a portion of the application stream to produce a decoded video stream. The method may also include decoding at least a portion of the application stream to produce a decoded video stream. In embodiments, the notification can include a prompt to accept a call. Further, the application stream may include at least a portion of a phone call.

In general, the first endpoint device can have a first operating system and the second endpoint device may have a second, different operating system. The second, different operating system can have a different interface, language, memory management technique, communication protocol, encryption, network stack, or any combination thereof, from the first operating system.

In example embodiments, a system can include a first endpoint device including one or more processors and storing executable instructions configured to manipulate the one or more processors to perform one or more of the methods disclosed herein.

In other example embodiments, a system may include an endpoint device framework including one or more endpoint devices communicatively coupled to one or more other endpoint devices, the system configured to perform one or more of the methods disclosed herein.

### DETAILED DESCRIPTION

Techniques and systems described herein provide flexibility in a device ecosystem of endpoint devices through the sharing of applications across one or more of the endpoint devices. Specifically, such techniques and systems described herein allow an endpoint device to run an application and share that application with one or more other endpoint devices such that the application is operated, partially operated, interactable, or partially simulated on the other endpoint devices. To initiate sharing of an application, a first endpoint device running an application generates notifications based on a condition or status of the application running. These notifications are provided to a second endpoint device and output by the second endpoint device. The second endpoint device receives interactions with the output notifications and provides these interactions to the first endpoint device. In response to interactions indicating the initiation of application sharing, the first endpoint device generates an application stream relating to the running application and provides it to the second endpoint device. In this way, application sharing is initiated between endpoint devices through notifications related to an application being shared between the devices.

Further, to share an application between endpoint devices, the first endpoint device generates an application stream based on an application running on the first endpoint device and provides it to a second endpoint device. The second endpoint device outputs the application stream and receives interactions with the output application stream. The second endpoint device provides the interactions with the application stream to the first endpoint device. The first endpoint device then modifies the application running on the first endpoint device based on the interactions with the application stream and generates a modified application stream based on the modified application. In this way, the application running on the first endpoint device is shared with the second endpoint device such that the application is operated, partially operated, interactable, or partially simulated on the second endpoint device.

Additionally, the techniques and systems as described herein allow for operating system agnostic system application sharing between endpoint devices. That is to say, an endpoint device having a first operating system shares applications with one or more endpoint devices having one or more different operating systems. Such a framework allows for more flexibility in sharing applications within a device ecosystem.

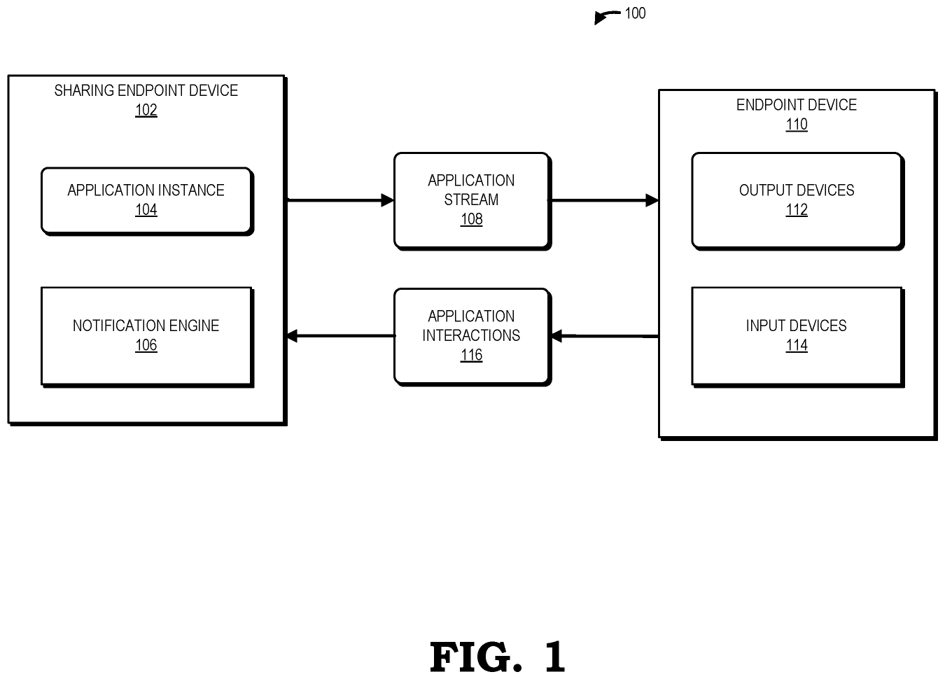

FIG. 1 illustrates an endpoint device framework 100 for cross-device application sharing, according to some embodiments. Endpoint device framework 100 includes one or more sharing endpoint devices 102 each communicatively coupled to at least one other endpoint device 110 and is configured to allow one or more applications to be shared between one or more sharing endpoint devices 102 and one or more other endpoint devices 110. Such applications include, for example, telecom applications (e.g., phone calls, video calling, voice over internet protocol (VoIP)) applications), messaging applications, media presentation applications, virtual assistant applications, gaming applications, shopping applications, encryption applications, decryption applications, web browser applications, and navigation applications, to name a few. Communicatively coupled, for example, includes two or more devices each configured to allow the transmission of data, reception of data, or both between them, for example, by wired communications, wireless communications, networked communications, bridged communications, or the like, to name a few. A “sharing endpoint device” and “endpoint device,” as used herein, each includes hardware and software resources configured to run one or more applications and includes, for example, one or more desktop computers, servers, virtual servers, notebook computers, tablet computers, virtual-reality systems, augmented reality systems, a compute-enabled cellular phone (i.e., a “smartphone”), compute-enabled wearable devices (i.e., “wearables”), a communication hub, a vehicle-integrated display, a compute-enabled display (i.e., a “smart display”), a compute-enabled television, (i.e., a “smart TV”), compute-enabled glasses, a compute-enabled speaker, a compute-enabled camera, a compute-enabled alarm, a drone, or any combination thereof.

In embodiments, one or more sharing endpoint devices 102 are configured to run and share one or more applications with one or more other communicatively coupled endpoint devices 110 such that the shared applications are operated, partially operated, interactable, or partially simulated on the endpoint devices 110. For example, in the example embodiment illustrated in FIG. 1, a sharing, or first, end point device 102 is configured to share one or more applications with a second endpoint device 110 such that the applications are operated, partially operated, interactable, or partially simulated on the second endpoint device 110. To facilitate the sharing of applications to another endpoint device 110, a sharing endpoint device 102 is configured to run a corresponding application instance 104 for each application to be shared. An application instance 104 includes software and hardware to facilitate the execution of at least a portion of an application to be shared to another endpoint device 110. Such facilitation includes performing one or more operations of an application, for example, rendering video frames, rendering audio data, controlling data streams, call processing, message processing, network management, communication management, authentication processes, notification generation, or any combination thereof, to name a few. According to embodiments, data resulting from the operations performed by an application instance 104 is provided to one or more communicatively coupled endpoint devices 110 as an application stream 108. As used herein, an “application stream” includes one or more data streams allowing for an application to be operated, partially operated, interactable, or partially simulated on one or more other endpoint devices. Such data streams include, for example, video streams, audio streams, control data streams, encrypted data streams, or any combination thereof, to name a few. For example, a sharing endpoint device 102 provides an application stream 108 including an encoded video stream and an encoded audio stream of a video call to an endpoint device 110.

According to embodiments, one or more sharing endpoint devices 102 each include a notification engine 106 configured to generate one or more application notifications related to applications running on the sharing endpoint device 102. Application notifications generated by a notification engine 106 include, for example, user prompts (e.g., prompt to enter information, prompt to enable services, prompt to activate hardware, prompt to select, prompt to confirm), application statuses (e.g., data being received by an application, authorizations of the application, activation of the application, deactivation of the application), application outputs (e.g., data generated by the application, values calculated by the application, video data, audio data), or any combination thereof. In embodiments, application notifications generated by a notification engine 106 are configured to be visually, audibly, or tactilely output by an endpoint device. For example, application notifications generated by a notification engine 106 are configured to be displayed on a screen. As another example, application notifications generated by the notification engine 106 are configured to induce a vibration of an endpoint device. According to embodiments, application notifications generated by a notification engine 106 include one or more push notifications. In embodiments, a sharing endpoint device 102 is configured to transmit one or more application notifications generated by a notification engine 106 to a communicatively coupled endpoint device 110. For example, a sharing endpoint device 102 is configured to transmit an application notification to an endpoint device 110 indicating that a call is being received by the application running on the sharing endpoint device 102. As another example, a sharing endpoint device 102 is configured to transmit an application notification to an endpoint device 110 prompting a user to turn on a camera of the endpoint device 110. According to embodiments, a sharing endpoint device 102 is configured to output one or more notifications generated by a notification engine 106 of the sharing endpoint device 102 and receive one or more interactions with the output notifications using one or more input devices.

An endpoint device 110 receiving an application stream 108 or application notifications from a sharing endpoint device 102 includes output devices 112 configured to output at least a portion of a received application stream 108 or received application notifications. Output devices include, for example, one or more displays (e.g., cathode ray tube (CRT), liquid crystal display (LCD), light-emitting diode (LED), organic light-emitting diode (OLED), and plasma displays), audio devices (e.g., full-range drivers, mid-range drivers, coaxial drivers, loudspeakers, tweeters, woofers, subwoofers, and crossovers), tactile output devices (e.g., kinaesthetic communication devices, haptic feedback devices, or vibration motors). As an example, an endpoint device 110 includes a display configured to output the video stream of received application stream 108. As another example, an endpoint device 110 includes a speaker configured to output an audio stream of a phone call from a received application stream 108. As yet another example, an endpoint device includes a display configured to output a notification including a user prompt to activate a camera of endpoint device 110.

In embodiments, an endpoint device 110 includes input devices 114 configured to receive one or more interactions. Input devices include, for example, one or more devices configured to receive a user interaction, for example, touchscreens, keyboard, remote controls, virtual keyboards, mice, joysticks, controller pads, microphones, accelerometers, proximity sensors, cameras, or the like. Interactions include, for example, gestures on a touchscreen, mouse clicks, button presses, wheel clicks, keyboard strokes, voice into a microphone, movements of an endpoint device, hand gestures, or any combination thereof, to name a few. In embodiments, an endpoint device 110 outputting at least a portion of a received application stream 108 is configured to receive one or more interactions relative to the portion of the application stream 108 being output. That is to say, the endpoint device 110 is configured to receive interactions with the application represented by the received application stream 108 being output. As an example, an endpoint device 110 receives an application stream 108 representing an application run on sharing endpoint device 102 and including a video stream. While the endpoint device 110 outputs the video stream of the application stream 108, the endpoint device 110 receives interactions relative to the output video stream, for example, gestures on a touch screen, mouse clicks, remote control button presses (e.g., interactions with buttons of a remote control), or any combination thereof. Similarly, an endpoint device 110 outputting a received notification is configured to receive one or more interactions relative to the output notification. In other words, the endpoint device 110 receives interactions with the notification being output by the endpoint device 110. AS an example, an endpoint device 110 that displays a notification including a user prompt receives interactions relative to the user prompt, for example, gestures on a touch screen, mouse clicks, remote control button presses (e.g., interactions with buttons of a remote control), or any combination thereof.

An endpoint device 110 is configured to transmit one or more application interactions 116 related to an application to a sharing endpoint device 102 sharing the application. “Application interactions,” as used herein, include data representing one or more interactions with a portion of an application stream 108 output by an endpoint device 110. According to embodiments, application instance 104 is configured to modify the execution of the shared application running on application instance 104 based on the received application interactions 116. For example, application instance 104 provides the application interactions 116 to the shared application as one or more inputs, determines one or more inputs for the shared application based on the application interactions, ends the execution of the shared application, launches another application, executes another portion of the shared application, or any combination thereof, to name a few. In this way, an application running on a sharing endpoint device 102 is operated, partially operated, interactable, or partially simulated on the endpoint device 110. As an example, an application instance 104 of a sharing endpoint device 102 renders an audio and video stream of a video call and provides the audio and video stream as application stream 108 to an endpoint device 110. The endpoint device 110 outputs the audio and video of the video stream and receives a user input of audio via a microphone. The endpoint device 110 then transmits the user input as an application interaction 116 to the sharing endpoint device 102 providing the application stream 108. The application instance 104 then modifies the shared application based on the received user input, for example, by providing the audio of the user input to another device associated with the video call.

According to embodiments, an endpoint device 110 is configured to transmit one or more notification interactions to a sharing endpoint device 102, for example, the sharing endpoint device that generated the application notifications. “Notification interactions,” as used herein, include data representing one or more interactions with a notification output by an endpoint device 110. In embodiments, an application instance 104 of a sharing endpoint device 102 is configured to initiate an application sharing session based on one or more notification interactions. Initiating an application sharing session includes, for example, initiating an application stream, providing a notification interaction as an input to an application, determining an input to an application, launching an application, performing at least a portion of an application, generating one or more subsequent application notifications, or any combination thereof. For example, a sharing endpoint device 102 generates a notification prompting a user to answer or decline an incoming call and transmits the notification to an endpoint device 110. The endpoint device 110 displays the notification and receives a user interaction with the prompt as a gesture on a touchscreen and transmits this notification interaction to the sharing endpoint device 102. In response to receiving the notification interaction, application instance 104 initiates application sharing by initiating and transmitting application stream 108 to endpoint device 110.

In embodiments, each sharing endpoint device 102 and endpoint device 110 of endpoint device framework 100 includes one or more operating systems each having, for example, one or more interfaces, languages, memory management techniques, communication protocols, encryptions, network stacks, or any combination thereof, to name a few. According to embodiments, the endpoint device framework 100 is configured to be operating system agnostic. “Operating system agnostic,” as used herein, includes endpoint device framework 100 configured to support at least one sharing endpoint device 102 having a first operating system and at least one other endpoint device 110 having a second, distinct operating system. That is to say, within endpoint device framework 100, a sharing endpoint device 102 with a first operating system shares one or more applications with an endpoint device 110 with a second, different operating system that includes one or more different interfaces, memory management techniques, communication protocols, network stacks, or any combination thereof, from the first operating system. For example, a sharing endpoint device 102 includes a first operating system having a first interface and a first memory management system. Within the endpoint device framework 100, the sharing endpoint device 102 shares one or more applications with an endpoint device 110 having a second, different operating system with a second, distinct interface and a second, distinct memory management system. By initiating application sharing using one or more notifications transmitted between endpoint devices within endpoint device framework 100, endpoint device framework 100 is operating system agnostic. For example, using one or more standard communication protocols (e.g., Bluetooth, Wi-Fi, LTE) a sharing endpoint device 102 transmits one or more notifications to another endpoint device 110 configured to interact with the notifications. When data representing these interactions are transmitted to the sharing endpoint device over the standard communication protocols, the sharing endpoint device 102 determines one or more responses to the interactions, for example, initiating an application stream 108 and transmitting the application stream to the other endpoint device using the standard communication protocols. In this way, a sharing endpoint device 102 within endpoint device framework 100 shares one or more applications with one or more other endpoint devices in an operating system agnostic manner.

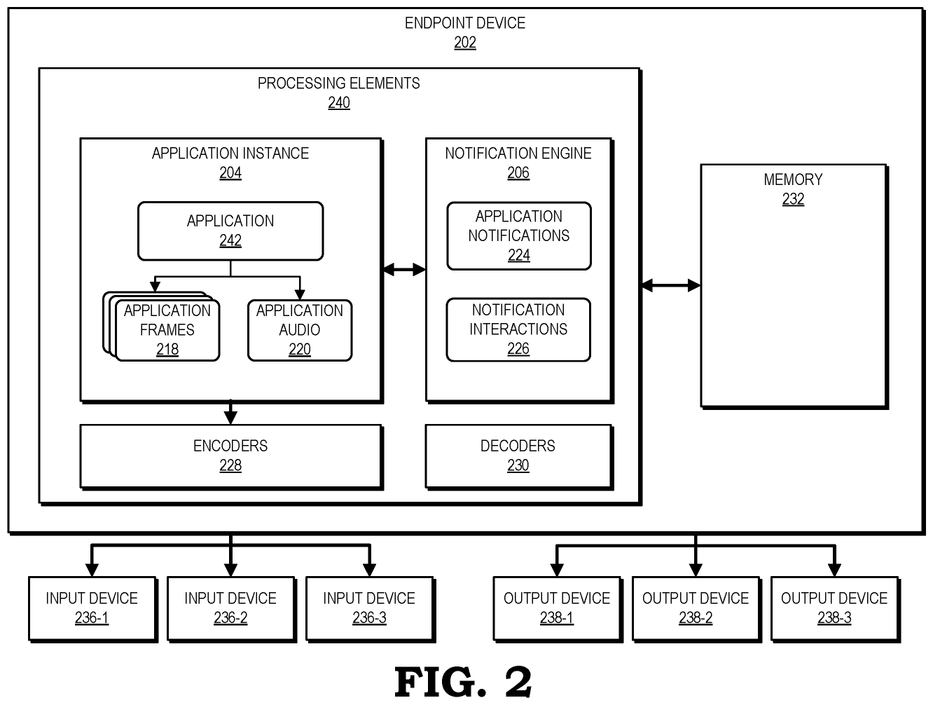

Referring now to FIG. 2, an example endpoint device 202 configured to share one or more applications is presented. In embodiments, endpoint device 202 implements aspects of endpoint device framework 100 as described in FIG. 1. For example, endpoint device 202 may be similar to or the same as a sharing endpoint device 102 or endpoint device 110 described in FIG. 1. According to some embodiments, endpoint device 202 is part of an electronic device that supports the sharing of an application, including, for example, a desktop computer, a notebook computer, a drone, a tablet computer, a virtual-reality system, an augmented reality system, a smartphone, a communication hub, a smart display, or a smart tv, to name a few.

In embodiments, endpoint device 202 includes processing elements 240 communicatively coupled to memory 232. Memory 232 includes an electronic storage device, for example, a solid-state drive, a hard disk drive, random access memory (“RAM”), read-only memory (“ROM”), electronically erasable programmable ROM (“EEPROM”), optical storage device, or any combination thereof. Memory 232 includes instructions and data related to the execution of one or more applications and the sharing of the one or more applications, for example, device identification data, codecs, messaging protocols, encryption data, decryption data, reference frames, or any combination thereof, to name a few.

According to embodiments, processing elements 240 include one or more control processing units (CPUs), microprocessors, field-programmable gate arrays (FPGAs), graphics processing units (GPUs), application-specific integrated circuits (ASICs), or any combination thereof and are configured to import and export one or more system services to and from one or more other endpoint devices. In embodiments, endpoint device 202 includes application instance 204, similar to or the same as application instance 104, including hardware and software configured to run at least a portion of one or more applications 242. According to embodiments, application instance 204 is configured to render one or more application frames 218 based on one or more applications 242 run by the application instance 204. In embodiments, each rendered application frame 218 represents at least a portion of a visual environment associated with an application 242, for example, a video call, a movie scene, a television scene, a heads-up display (HUD), a graphical user interface (GUI), or any combination thereof, to name a few. In embodiments, application instance 204 is configured to render application audio 220 based on one or more applications run by the application instance 204. According to embodiments, the rendered application audio 220 represents sounds, music, or dialogue associated with an application 242, for example, audio from a phone call, audio from a video call, songs, sound effects, or any combination thereof, to name a few.

In embodiments, processing elements 240 include one or more encoders 228 that include hardware and software configured to encode application frames 218 and application audio 220 rendered by application instance 204 so as to generate respective video streams and audio streams. The encoders 228 are configured to encode application frames 218 and application audio 220 through, for example, compression, reorganization, and manipulation of application frames 218 and application audio 220. According to embodiments, each encoder 228 implements one or more codecs to encode application frames 218 and application audio 220. In embodiments, video streams and audio streams generated by encoders 228 are transmitted to another endpoint device as at least a portion of an application stream 108. In this way, video and audio for a respective application 242 are rendered on endpoint device 202 and shared with another endpoint device to allow the respective application 242 to be operated, partially operated, interactable, or partially simulated on the other endpoint device.

According to embodiments, endpoint device 202 includes or is communicatively coupled to one or more output devices 238, similar to or the same as output devices 112, configured to output at least a portion of a received application stream 108. For example, a display to output a video stream of an application stream 108, a speaker to output an audio stream of an application stream 108, or a touchscreen to output a GUI, to name a few. In embodiments, endpoint device 202 includes or is communicatively coupled to one or more input devices 236, similar to or the as input devices 114, configured to receive interactions with portions of an application stream 108 output by output devices 238. That is to say, input devices 236 are configured to receive interactions with one or more applications 242 shared with endpoint device 202. For example, a touchscreen to receive interactions with an application stream 108 output on a display, a microphone to receive interactions with a phone call application being output, or remote control buttons (e.g., buttons of a remote control) to receive interactions related to an audio stream output by a speaker, to name a few. Though the example embodiment illustrated in FIG. 2 presents an endpoint device 202 including or communicatively coupled to three input devices (236-1, 236-2, and 236-3) and three output devices (238-1, 238-2, and 238-3), in other embodiments, an endpoint device 202 can include or be communicatively coupled to any number of input devices 236 and any number of output devices 238.

In embodiments, endpoint device 202 includes one or more decoders 230 that each include hardware and software configured to decode one or more portions of an application stream 108. For example, decoders 230 are configured to decode encoded video and audio streams of an application stream 108. The decoders 230 are configured to decode application frames and application audio through, for example, compression, reorganization, and manipulation of an application stream 108. In embodiments, each decoder 230 implements one or more codecs to decode application frames and application audio from an application stream 108. Decoders 230 are configured to provide any decoded application frames, video streams, and application audio data from an application stream 108 to one or more output devices 238 for output.

Endpoint device 202 includes a notification engine 206, similar to or the same as notification engine 106, that includes hardware and software configured to generate one or more application notifications 224 relating to one or more applications 242 run by application instance 204. Application notifications 224 include, for example, user prompts (e.g., prompt to enter information, prompt to enable services, prompt to activate hardware, prompt to select, prompt to confirm), application statuses (e.g., data being received by an application, authorizations of the application, activation of the application, deactivation of the application), application outputs (e.g., data generated by the application, values calculated by the application, video data, audio data), or any combination thereof. In embodiments, application notifications 224 are configured to be visually, audibly, or tacitly output by one or more output devices. For example, an application notification 224 is configured to be displayed on an output device 238 including a screen. According to embodiments, notification engine 206 is configured to generate one or more application notifications 224 based on a condition of an application 242 run on application instance 204. A “condition of an application” or “application condition,” as used herein, indicates, for example, a status of an application 242 (e.g., the application is out of date, the application is running, the application is suspended, the application has ended), data received by an application 242 (e.g., an incoming phone call, incoming video call, update data, files, video streams, audio stream), progress of one or more operations of an application 242 (e.g., completion of an operation, an output of an operation, the initiation of an operation), or any combination thereof. Based on a condition of an application (e.g., application condition), notification engine 206 is configured to determine and generate one or more application notifications 224. In embodiments, notification engine 206 is configured to generate application notifications 224 based on the condition of an application 242 using, for example, look-up tables, relational databases, or both. In embodiments, notification engine 206 is configured to generate one or more application notifications 224 to initiate application sharing of an application 242 running on application instance 204 with another endpoint device. That is to say, notification engine 206 is configured to determine one or more user prompts, application statuses, or application outputs necessary to, helpful for, or aiding in sharing an application 242 with another endpoint device. For example, notification engine 206 generates a notification including a user prompt to activate a camera of another endpoint device for sharing a video calling application with the other endpoint device. As another example, notification engine 206 generates a notification including an available video for sharing a video streaming application with the other endpoint device. In embodiments, endpoint device 202 is configured to transmit one or more application notifications 224 to one or more other endpoint devices. According to embodiments, an endpoint device 202 is configured to output one or more notifications generated by a notification engine 206 of the endpoint device using one or more output devices 238 and receive one or more interactions with the output notifications using one or more input devices 236. Based on the received interactions, an application instance 204 is configured to modify one or more applications 242 running on the endpoint device 202.

According to embodiments, an endpoint device 202 receives one or more application notifications 224 relating to an application 242 running on at least one other endpoint device. Endpoint device 202 is configured to output the received application notifications to one or more output devices 238. For example, endpoint device 202 is configured to display an application notification 224 including a user prompt to activate a microphone of the endpoint device on an output device 238 including a touchscreen. In embodiments, endpoint device 202 is configured to receive one or more notification interactions 226 with application notifications 224 output by one or more output devices 238 via one or more input devices 236. For example, endpoint device 202 is configured to receive a notification interaction 226 including one or more mouse clicks while an application notification 224 including a user prompt is displayed. As another example, endpoint device 202 is configured to receive a notification interaction 226 including one or more keyboard strokes while an application notification 224 including an application status is displayed. According to embodiments, endpoint device 202 transmits one or more notification interactions 226 to one or more other endpoint devices. For example, endpoint device 202 transmits one or more notification interactions 226 to the endpoint device running the application 242 relating to the notification interactions 226 (i.e., the application 242 the application notifications 224 received by the endpoint device 202 are related to).

In embodiments, notification engine 206 receives one or more notification interactions 226 from one or more other endpoint devices. Based on the received notification interactions 226, notification engine 206 initiates the sharing of one or more applications 242 running on application instance 204. For example, notification engine 206 compares one or more received notification interactions 226 to one or more strings, look up tables, or databases. In response to the comparison indicating the initiation of application sharing, notification engine 206 initiates the sharing of one or more applications 242. Notification engine 206 initiates the sharing of one or more applications 242 by, for example, initiating an application stream 108, providing a notification interaction 226 as an input to an application 242, determining an input to an application 242, launching an application 242, performing at least a portion of an application 242, generating one or more subsequent application notifications 224, or any combination thereof. In this way, application notifications 224 are used to initiate the sharing of one or more applications 242 between two or more endpoint devices.

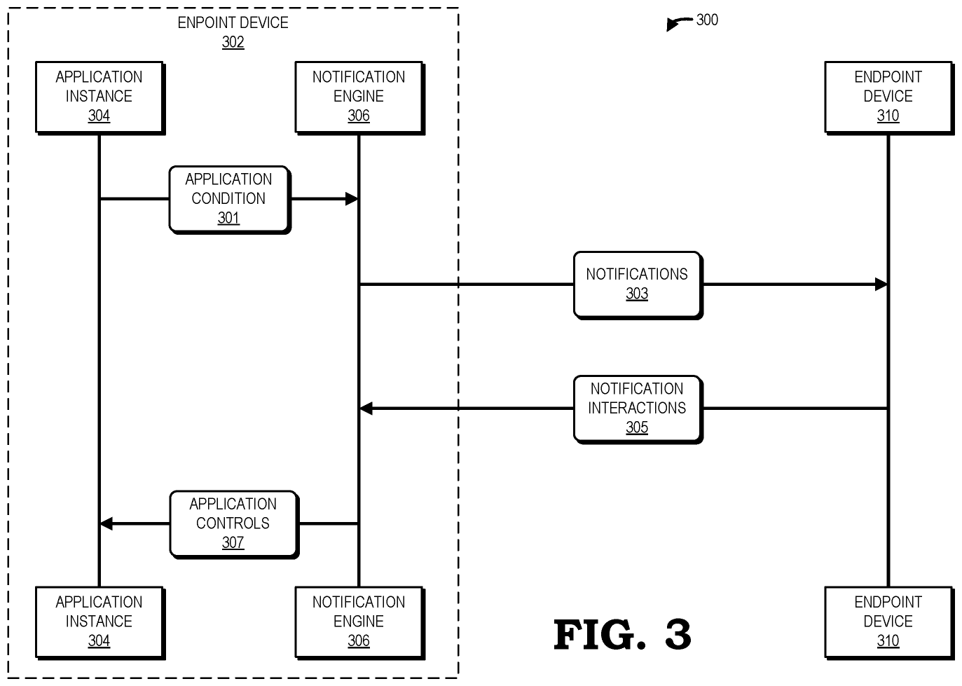

FIG. 3 presents an example application sharing initiation operation 300. In embodiments, a first endpoint device 302, similar to or the same as sharing endpoint device 102, is configured to share one or more applications running on an application instance 304, similar to or the same as application instance 104, with a second endpoint device 310, similar to or the same as endpoint device 110. The first endpoint device 302 also includes a notification engine 306, similar to or the same as notification engine 106, configured to generate one or more application notifications related to the applications running on application instance 304. The initiation operation 300 includes the notification engine 306 of the first endpoint device 302 determining the application condition 301 of one or more applications running on application instance 304. Application condition 301 indicates the status of applications running on application instance 304, data received by the applications running on application instance 304, the progress of one or more operations of applications running on application instance 304, or any combination thereof. Based on the determined application condition 301, the notification engine 306 is configured to generate one or more notifications 303 that are necessary to, helpful for, or aiding in sharing an application running on application instance 304 with the second endpoint device 310. For example, the notification engine 306 compares the determined application condition 301 to one or more strings, lookup tables, databases, or any combination thereof to determine and generate one or more notifications 303 that are necessary to, helpful for, or aiding in sharing an application running on application instance 304 with the second endpoint device 310. As an example, based on a determined application condition 301 of an incoming phone call, notification engine 306 generates a notification 303 including a user prompt to accept or decline the call.

The first endpoint device 302 is configured to transmit the generated notifications 303 to the second endpoint device 310. The second endpoint device 310 is configured to output any visual, audio, or tactile data of the notifications 303 on one or more output devices. While the notifications 303 are output by the second endpoint device 310, the second endpoint device 310 is configured to receive one or more interactions with the output notifications 303 via one or more input devices. That is to say, second endpoint device 310 is configured to receive one or more notification interactions 305. For example, the second endpoint device 310 receives one or more button presses, gestures on a touchscreen, audio inputs into a microphone, mouse clicks, keystrokes, or any combination thereof, interacting with the output notifications 303. The second endpoint device 310 is configured to transmit data representing one or more received notification interactions 305 to the first endpoint device 302.

Based on the data representing one or more received notification interactions 305 received from the second endpoint device 310, the notification engine 306 of the first endpoint device 302 determines whether application sharing should be initiated, i.e., whether an application running on application instance 304 should be shared with the second endpoint device 310. For example, the notification engine 306 compares the data representing one or more received notification interactions 305 to one or more strings, lookup tables, databases, or any combination thereof and determines whether the comparison indicates an application running on application instance 304 should be shared with the second endpoint device 310. In response to determining that one or more applications running on application instance 304 are to be shared with the second endpoint device 310, the notification engine 306 generates one or more application controls 307. Application controls 307 include one or more inputs, commands, messages, or any combination thereof directing application instance 304 to initiate an application stream, provide a notification interaction 305 as an input to an application running on application instance 304, ignore an application running on application instance 304, provide an input to an application running on application instance 304, launch an application, perform at least a portion of an application, or any combination thereof. In this way, notifications 303 generated by notification engine 306 are used to initiate an application sharing session between endpoint devices.

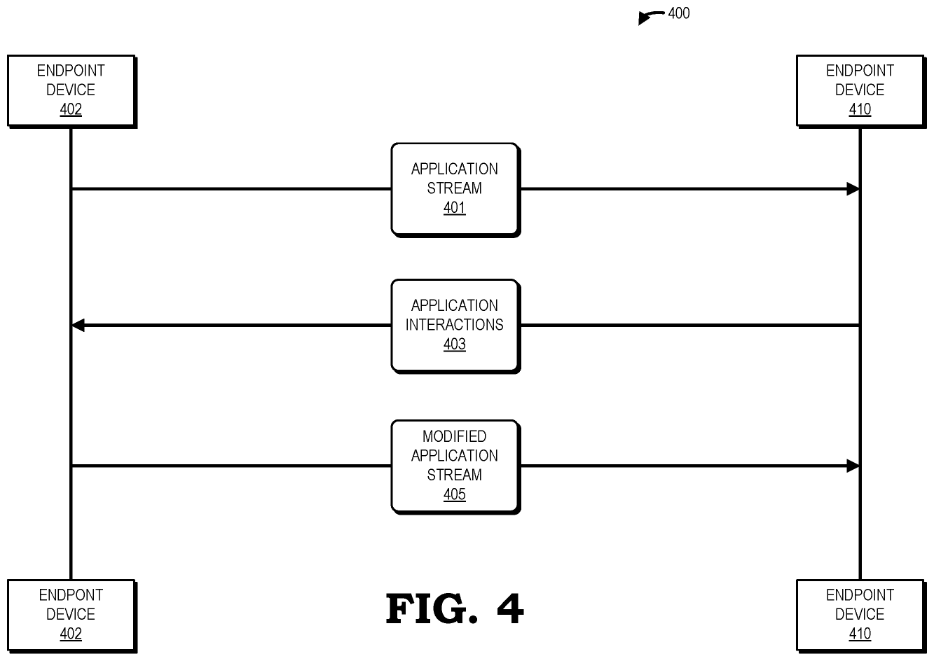

FIG. 4 presents an example application sharing operation 400. In embodiments, a first endpoint device 402, similar to or the same as sharing endpoint device 102, is configured to share one or more applications running on the first endpoint device 402 with a second endpoint device 410, similar to or the same as endpoint device 110. In embodiments, sharing operation 400 includes the first endpoint device 402 generating an application stream 401. Application stream 401 includes one or more encoded video streams, encoded audio streams, control data streams, encrypted data streams, or any combination thereof, related to one or more applications running on the first endpoint device 402. The first endpoint device 402 transmits the application stream 401 to the second endpoint device 410.

The second endpoint device 410 includes one or more output devices configured to output at least a portion of a received application stream, 401. For example, the second endpoint device 410 includes a display to output an encoded video stream of an application stream 401 and a speaker to output an encoded audio stream of the application stream 401. While the application stream 401 is output by the second endpoint device 410, the second endpoint device 410 receives interactions relative to the output portions of the application stream 401 via one or more input devices. That is to say, the second endpoint device 410 receives one or more interactions with the applications related to the application stream 401 (e.g., application interactions 403). As an example, the second endpoint device 410 receives keyboard strokes interacting with a video stream of an application stream 401 being output and touchscreen gestures interacting with a GUI of application stream 401. The second endpoint device 410 transmits data representing one or more received application interactions 403 to the first endpoint device 402 (e.g., the endpoint device that sent the application stream 401).

Based on the received data representing one or more received application interactions 403 from the second endpoint device 410, the first endpoint device 402 modifies one or more applications running on the first endpoint device 402. The first endpoint device 402 modifies the applications by, for example, providing the data representing one or more received application interactions 403 to one or more applications, initiating an application, terminating an application, determining an input for an application, or any combination thereof. In response to modifying one or more applications running on the first endpoint device 402, a modified application stream 405 is generated based on the modified applications. The modified application stream 405 is then provided to the second endpoint device. In this way, one or more applications running on the first endpoint device 402 are shared with the second endpoint device 410 such that one or more applications running on the first endpoint device 402 are operated, partially operated, interactable, or partially simulated on the second endpoint device 410.

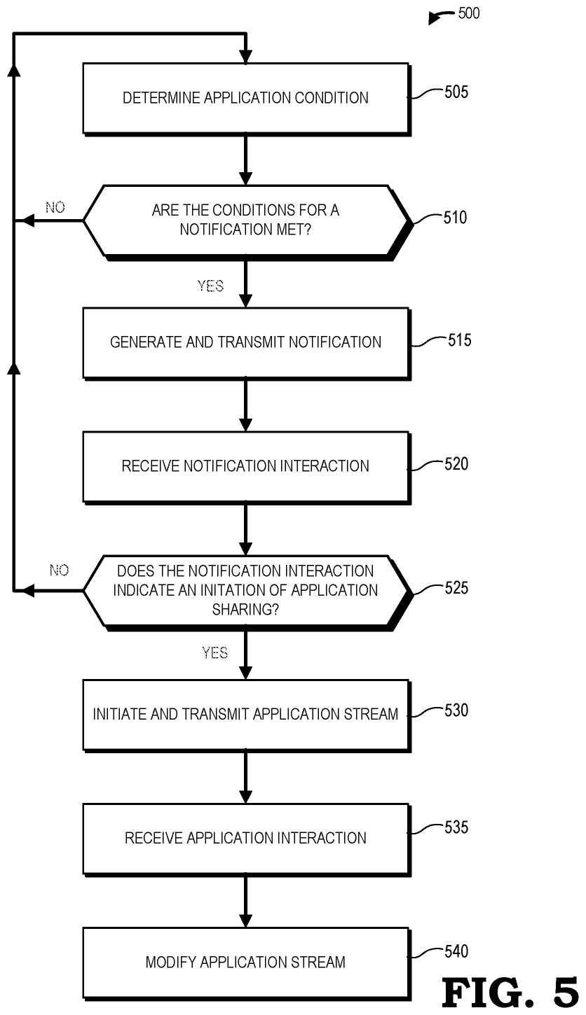

Referring now to FIG. 5, a flow diagram of an example application sharing operation 500 is illustrated. At block 505, a notification engine, similar to or the same as notification engine 106, of a first endpoint device, similar to or the same as sharing endpoint device 102, determines the condition of one or more applications running on the first endpoint device indicating, for example, the status of the applications, data received by the applications, the progress of one or more operations of the applications, or any combination thereof. At block 510, the notification engine determines if the conditions for a notification are met. For example, the notification engine compares the determined conditions of the application to one or more strings, lookup tables, databases, or any combination thereof and determines if the comparison indicates that the conditions for a notification are met. In response to the conditions for a notification not being met, the system moves back to block 505. In response to the conditions for a notification being met, the system moves to block 515.

At block 515, the notification engine generates one or more notifications related to one or more applications running on the first endpoint device. As an example, the notification engine generates one or more notifications based on the comparison of the determined conditions of the application to one or more strings, lookup tables, databases, or any combination thereof. Further, the notification engine transmits the generated notifications to a second endpoint device, similar to or the same as endpoint device 110. At block 520, the second endpoint device outputs one or more received notifications using one or more output devices. Further, at block 520, the second endpoint device receives one or more notification interactions with one or more output notifications via one or more input devices. The second endpoint device transmits data representing the notification interactions to the first endpoint device.

At block 525, the first endpoint device determines whether one or more notification interactions represented in the received data indicate the initiation of application sharing. For example, the first endpoint device compares the data representing the notification interactions to one or more strings, lookup tables, databases, or any combination thereof and determines if the comparison indicates that application sharing is to be initiated. In response to none of the interactions indicating the initiation of application sharing, the system moves back to block 505. In response to one or more notifications indicating that application sharing is to be initiated, the system moves to block 530. At block 530, the first endpoint device initiates an application stream representing at least a portion of one or more applications running on the first endpoint device. The application stream is then provided to the second endpoint device. In other words, the first endpoint device shares one or more applications with the second endpoint device.

At block 535, the second endpoint device outputs at least a portion of a received application stream using one or more output devices. While portions of the application stream are output, the second endpoint device is configured to receive one or more application interactions with the portions of the application stream being output via one or more input devices. That is to say, the second endpoint device receives one or more application interactions with the applications shared from the first endpoint device. The second endpoint device then transmits data representing the application interactions to the first endpoint device. At block 540, the first endpoint device modifies one or more applications running on the first endpoint device based on the application interactions. For example, the first endpoint device compares one or more application interactions to one or more strings, lookup tables, databases, or any combination thereof and determines a modification from the comparison. Such modifications include, for example, providing the data representing one or more application interactions, initiating an application, terminating an application, determining an input for an application, or any combination thereof. From the modified applications running on the first endpoint device, the first endpoint device generates a modified application stream and transmits it to the second endpoint device.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still, further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method, comprising:
generating a notification related to an application running on a first endpoint device;
receiving, from a second endpoint device, a signal representing an interaction with the notification;
initiating an application stream based on the interaction with the notification; and
transmitting, by the first endpoint device, the application stream to the second endpoint device.

2. The method of claim 1, further comprising:
determining a condition of the application running on the first endpoint device, wherein the notification related to the application is generated based on the condition of the application.

3. The method of claim 2, wherein the condition comprises an incoming phone call.

4. The method of claim 1, further comprising:
determining an application control based on the interaction with the notification, wherein the application stream is initiated further based on the application control.

5. The method of claim 4, wherein the application control comprises at least one of an application stream initiation, an application quit, an application ignore, or an application command.

6. The method of claim 1, further comprising:
rendering a plurality of application frames based on the application running on the first endpoint device; and
encoding the plurality of application frames to produce at least a portion of the application stream.

7. The method of claim 6, wherein the application stream comprises at least a portion of a video call.

8. The method of claim 1, further comprising:
rendering audio data based on the application running on the first endpoint device; and
encoding the audio data to produce at least a portion of the application stream.

9. The method of claim 8, wherein the application stream comprises at least a portion of a phone call.

10. A method, comprising:
transmitting a notification related to an application running on a first endpoint device to a second endpoint device;
receiving, from the second endpoint device, data indicating an interaction with the notification;
in response to the data indicating the interaction with the notification, generating an application stream representing at least a portion of the application running on the first endpoint device; and
transmitting the application stream to the second endpoint device.

11. The method of claim 10, further comprising:
determining a condition of the application running on the first endpoint device; and
in response to determining the condition of the application, generating the notification related to the application.

12. The method of claim 10, further comprising:
rendering audio data based on the application running on the first endpoint device; and
encoding the audio data to produce an encoded audio stream.

13. The method of claim 12, wherein the application stream includes the encoded audio stream.

14. The method of claim 10, further comprising:
rendering a frame based on the application running on the first endpoint device; and
encoding the frame to produce an encoded video stream.

15. The method of claim 14, wherein the application stream includes the encoded video stream.

16. The method of claim 10, wherein the notification includes a prompt to accept a call.

17. The method of claim 10, wherein the notification includes a prompt to activate an input device of the second endpoint device.

18. The method of claim 10, further comprising:
receiving, at the first endpoint device, data representing an interaction with at least a portion of the application stream from the second endpoint device.

19. The method of claim 18, further comprising:
modifying the application running on the first endpoint device based on the interaction with at least a portion of the application stream.

20. The method of claim 18, further comprising:
generating a modified application stream based on the interaction with at least a portion of the application stream; and
transmitting the modified application stream to the second endpoint device.

21. A method, comprising:
outputting a notification related to an application running on a second endpoint device at a first endpoint device;
receiving an interaction with the notification;
transmitting data representing the interaction with the notification to the first endpoint device; and
receiving an application stream related to the application running on the second endpoint device from the second endpoint device.

22. The method of claim 21, wherein the notification is output by an output device including at least one of a display or speaker.

23. The method of claim 22, further comprising:
outputting at least a portion of the application stream by the output device.

24. The method of claim 21, wherein the interaction is received by an input device including at least one of a touchscreen, mouse, keyboard, remote control, or microphone.

25. The method of claim 24, further comprising:
receiving an interaction with the application stream by the input device; and
transmitting data representing the interaction with the application stream to the second endpoint device.

26. The method of claim 25, further comprising:
receiving a modified application stream based on the interaction with the application stream from the second endpoint device.

27. The method of claim 21, further comprising:
decoding at least a portion of the application stream to produce a decoded video stream.

28. The method of claim 21, further comprising:
decoding at least a portion of the application stream to produce a decoded audio stream.

29. The method of claim 21, wherein the notification includes a prompt to accept a call.

30. The method of claim 21, wherein the application stream includes at least a portion of a phone call.

31. The method of claim 21, wherein the first endpoint device has a first operating system, and the second endpoint device has a second, different operating system.

32. The method of claim 31, wherein the second, different operating system has at least one different interface, language, memory management technique, communication protocol, encryption, or network stack from the first operating system.

33. (canceled)

34. (canceled)
